(19) United States
(12) Patent Application Publication
(10) Pub. No.: US 2004/0075325 A1
(43) Pub. Date: Apr. 22, 2004

(54) Fitting for a vehicle seat

(75) Inventors: Uwe Assmann, Remscheid (DE); Mario Klein, Blumberg (DE); Eckhard Nock, Worms (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Keiper GmbH & Co. KG

(21) Appl. No.: 10/684,901

(22) Filed: Oct. 14, 2003

Related U.S. Application Data
(63) Continuation of application No. PCT/EP02/09535, filed on Aug. 27, 2002.

(30) Foreign Application Priority Data
Sep. 6, 2001 (DE) 101 44 832.5
Dec. 21, 2001 (DE) 201 20 768.0
Mar. 30, 2002 (DE) 102 14 453.2

(51) Int. Cl. B60N 2/22

(52) U.S. Cl. 297/362; 297/354.1

(57) ABSTRACT

In a fitting for a vehicle seat, particularly a motor vehicle seat, having a first fitting part (7), a second fitting part (8) pivotable relative to the first fitting part around an axis (A) defined by a bearing shaft (10), also having a compensation spring (12) acting between the first fitting part (7) and the second fitting part (8) through pretension, the compensation spring (12) bears, on the one hand, against the first fitting part (7) and, on the other hand, against a bearing component (20) of the second fitting part aligned with the axis (A).

### CROSS-REFERENCE TO RELATED APPLICATION

This is a continuation of PCT/EP02/09535, which was filed Aug. 27, 2002, and is entirely incorporated herein by reference.

### BACKGROUND OF THE INVENTION

The present invention concerns a fitting for a vehicle seat, particularly a motor vehicle seat, having a first fitting part and a second fitting part that is pivotable relative to the first fitting part around an axis defined by a bearing shaft, and having a compensation spring acting between the first fitting part and the second fitting part through pretension.

It is known that in fittings of this type and other adjusters, particularly in height adjusters, the weight of the component group to be moved by means of the fitting is compensated by a compensation spring, for example, a torsion spring. In this case, the force needed for activating the fitting in either possible direction of movement does not differ so greatly.

### BRIEF SUMMARY OF THE INVENTION

The object of the invention is to improve a fitting of the above-described type. This object is achieved, according to one aspect of the present invention, through the invention of a fitting for a vehicle seat, particularly a motor vehicle seat, having a first fitting part and a second fitting part that is pivotable relative to the first fitting part around an axis defined by a bearing shaft, and having a compensation spring acting between the first fitting part and the second fitting part through pretension, characterized in that one portion of the compensation spring bears on the first fitting part and another portion of the compensation spring bears on a bearing component of the second fitting part, with at least part of the bearing component of the second fitting part being aligned with the axis.

Because the compensation spring bears, on one hand, against the first fitting part and, on the other hand, against the bearing component of the second fitting part that is aligned with the axis, there is a simple and fast option for mounting the compensation spring on an existing fitting, without requiring too many mounting steps.

The compensation spring is preferably mounted on a polyhedron or bowl of the bearing component in order to hold the compensation spring in a defined position. Polyhedrons are meant to include all bodies having a longitudinal axis, around which are arranged at least two plane surfaces that are not coplanar and extend parallel to the longitudinal axis, for example, a so-called dihedron (two parallel, plane surfaces with curved surfaces in between), a trihedron (three-sided cross section), a tetrahedron (generally having a square cross section), etc.

Attaching the compensation spring by clamping a receiver formed in the spring to a polyhedral element of the bearing component has the advantage of holding the compensation spring without pretensioning. This procedure, for example, requires fewer coils and makes it possible to reduce the weight. To obtain this clamping attachment in a preferred manner, a pretensioning force produces a friction connection in the area of the receiver with respect to the polyhedral element, the friction connection being complemented by a profile or interlocking connection caused by the geometric conformity between the polyhedral element and the receiver. For mounting, the compensation spring can, for example, be shrunk onto the polyhedral element. For example, depending on requirements, the position of the spring base on the polyhedral element can also be chosen by selecting the position of an insert opening. Axial stabilizers for the compensation spring can be formed on the polyhedral element.

One end of the compensation spring that is preferably arranged on the outside of the fitting bears preferably against the receiver on the polyhedral element of the bearing component preferably projecting over the contour of the two fitting parts, and the other end bears against a shaft protruding from the outside of the fitting part that is movable relative to the bearing component. For this, the compensation spring is coiled preferably in the shape of a spiral. The polyhedral element is preferably, but not necessarily, formed onto the bearing component.

The invention can be used both for fittings with swing-free function, irrespective of their inner inclination setting construction, and for articulated fittings with table positions, packaging positions, floor positions, or similar positions. The arrangement of the fitting parts as an upper fitting part and a lower fitting part and/or on both sides of the vehicle seat depends on the intended use.

### BRIEF DESCRIPTION OF THE DRAWINGS

The following figures show the invention in detail with reference to four exemplary embodiments, each shown in three versions, and wherein:

FIG. 1 is a lateral view of the fitting according to the first exemplary embodiment,

FIG. 2 is a perspective view of a bushing according to the first exemplary embodiment,

FIG. 3 is another perspective view of the bushing in FIG. 2,

FIG. 4 is a section through the bearing shaft, bushing and screw,

FIG. 5 is a schematic lateral view of a vehicle seat,

FIG. 6 is a perspective view of a bushing as in FIG. 3, corresponding to a modification of the first exemplary embodiment,

FIG. 7 is a lateral view of the fitting according to the second exemplary embodiment,

FIG. 8 is a perspective view of the fitting according to the second exemplary embodiment without showing the compensation spring,

FIG. 9 is an isolated view of an exemplary compensation spring,

FIG. 10 is a view of a compensation spring according to the third exemplary embodiment,

FIG. 11 is a view of the compensation spring in FIG. 10 in a more highly tensioned state,

FIG. 12 is a lateral view of the third exemplary embodiment,

FIG. 13 is a section through the bearing shaft, bushing and screw along the line XIII-XIII in FIG. 15,

FIG. 14 is a schematic lateral view of a vehicle seat,

FIG. 15 is a longitudinal section through the third exemplary embodiment along the line XV-XV in FIG. 12,

FIG. 16 is a longitudinal section through a modification of the third exemplary embodiment,

FIG. 17 is a partial view of the fourth exemplary embodiment,

FIG. 18 is a perspective view of the bearing component of the fourth exemplary embodiment, and

FIG. 19 is a perspective view of a modification of the latter.

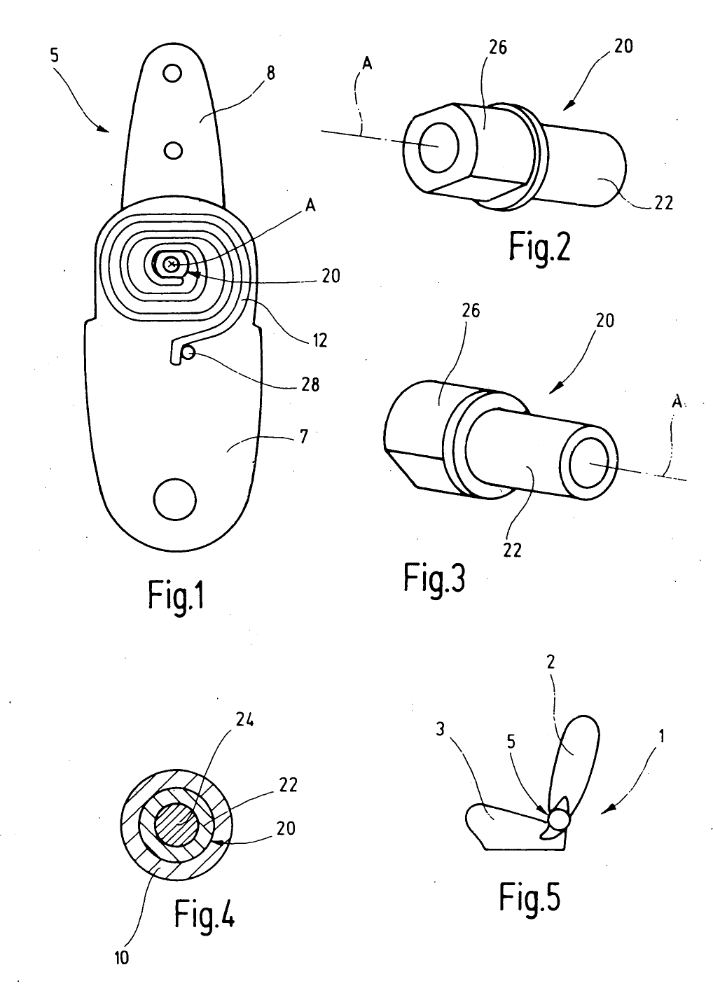

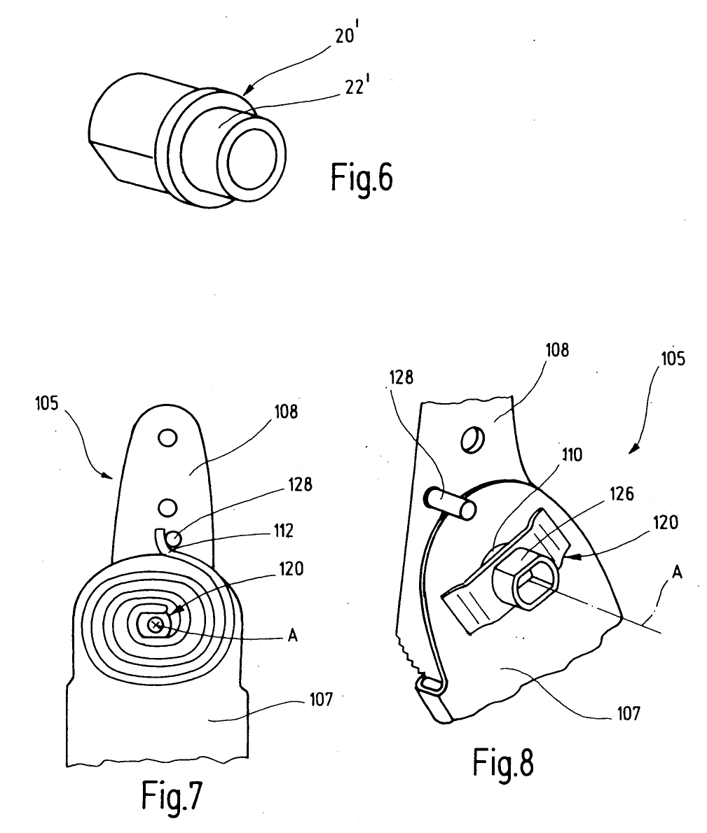

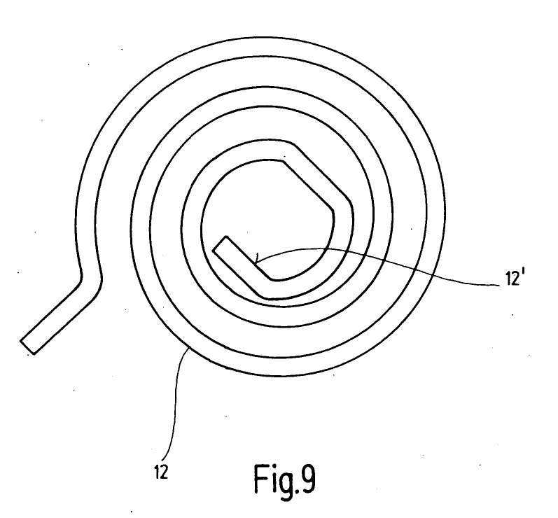

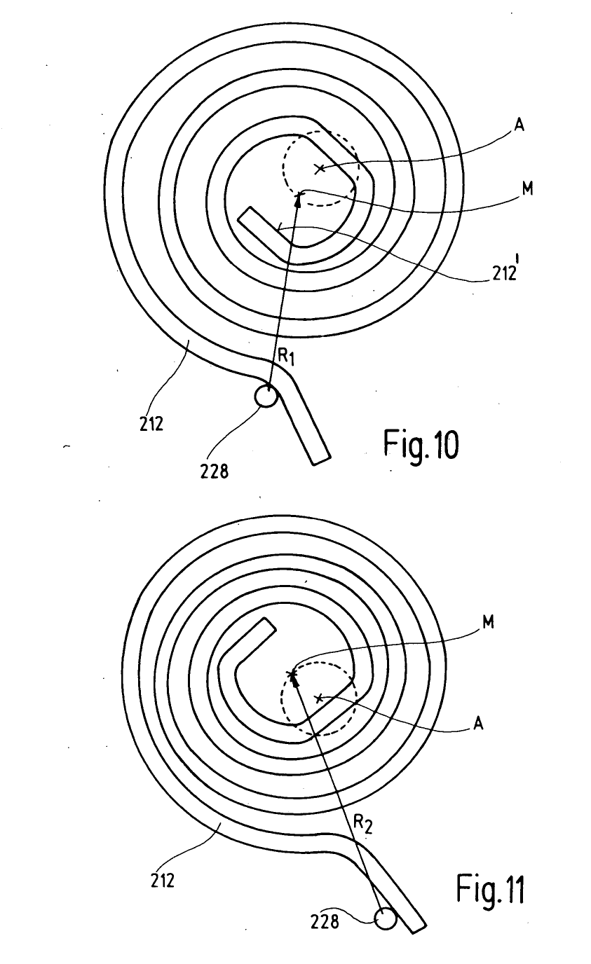

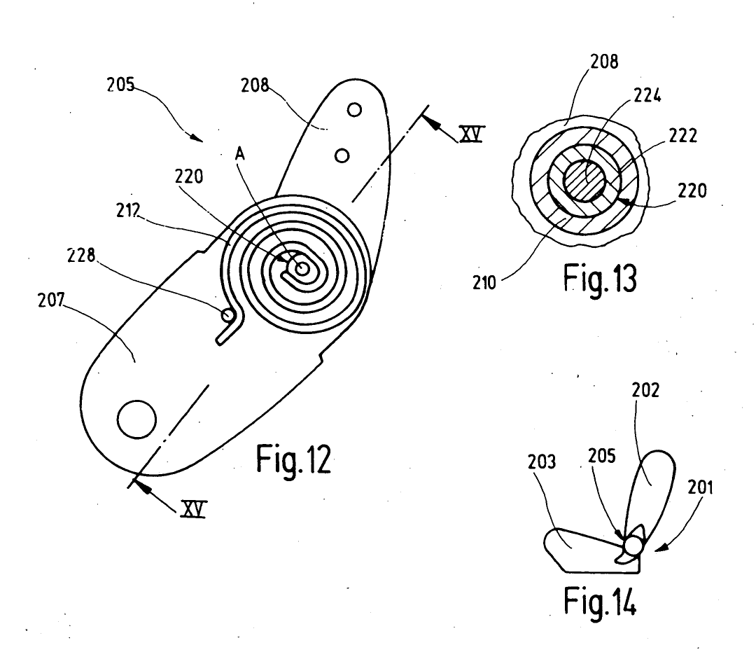

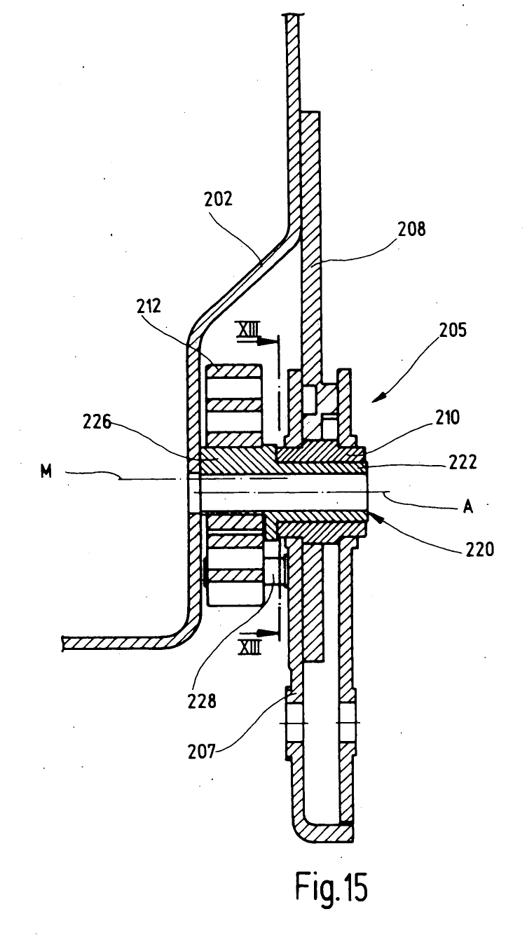

### DETAILED DESCRIPTION OF THE INVENTION

In a first exemplary embodiment, a vehicle seat 1, which is in a rear seat row of a motor vehicle, has a fitting 5 on either side for adjusting the inclination of its backrest 2 relative to the seat part 3. The fitting 5 is in the form of a lock fitting and includes a seat part-fixed lower fitting part 7 and a backrest-fixed upper fitting part 8, which can be pivoted relative to the lower fitting part 7 by means of a bearing shaft 10 journaled in the lower fitting part 7 in the way described below. The lower fitting part 7 includes two plate-shaped parallel elements having a mounting space for receiving the segment of the upper fitting part 8 enclosing the bearing shaft 10 and different locking and securing elements.

The central axis A defined by the bearing shaft 10 defines the pivoting axis of the backrest 2 and the direction that will be referred to as the axial direction in the following text. A steel compensation spring 12 is coiled spirally around the axis A and is anchored, on the one hand, on the lower fitting part 7 and, on the other hand, on the upper fitting part 8. The compensation spring 12 is shaped as a flat spring and has a rectangular cross section whose larger dimension extends in an axial direction.

In this first exemplary embodiment, the upper part-fixed bearing shaft 10 has an end-to-end longitudinal bore, into which a bushing 20 having a cylindrical section 22 is inserted as a bearing component. The bushing 20 is connected, for example, to the structure of the backrest 2 by means of an axially oriented screw 24, the cylindrical section 22 having an inner thread.

In an axial direction, the cylindrical section 22 becomes a dihedral section 26, with which the bushing 20 extends beyond the bearing shaft 10 and thereby over the contour of the fitting 5. To anchor the compensation spring 12 in a rotation-fixed manner, its inner end is shaped as a receiver 12′, the greater part of it being clamped on the upper part-fixed dihedral section 26, i.e. by friction connection along large areas by means of a pretension in the spring steel of the receiver 12′, for example by reason of a distance of the plane surfaces that is less than the dimensions of the dihedral section 26, the similarity of the geometries preferably causing a complementary profile or interlocking connection at least in some areas, for example in the bent area. The compensation spring 12 is thus firmly anchored even without pretension.

In the upright and backward inclined positions of the backrest 2, the outer end of the compensation spring 12, being pretensioned, bears on a lower part-fixed stop pin 28. The stop pin 28 extends from the outer side of the lower fitting part 7 and is arranged parallel to the dihedral section 26. A pivoting forward movement of the upper fitting part 8 is supported by the pretension of the compensation spring 12, to ensure that the backrest 2 gives the passenger firm support, or to enable the backrest to swing free more easily. When the forward inclination of the backrest 2 is more than 10°, the compensation spring 12 is in a released position without pretension, i.e. it detaches itself from the stop pin 28. The weight of the backrest 2 then supports further forward movement.

In a modification of the first exemplary embodiment, which is identical to the second exemplary embodiment unless described otherwise, the cylindrical section 22′ of the bushing 20′ is shorter than in the first exemplary embodiment, it is inserted into a blind hole of the bearing shaft 10 and also connected to the structure of the backrest 2 in a rotation-fixed manner.

The second exemplary embodiment is in many ways identical to the first exemplary embodiment, so that the reference numbers for identical components or components with identical functions are higher by 100. The fitting 105 also has a lower fitting part 107 and an upper fitting part 108 being pivotable by means of a bearing shaft 110 relative to the lower fitting part 107 around an axis A defined by the bearing shaft 110. As a bearing component, a bearing plate 120 welded onto the outer side of the lower fitting part 107 in the area of the bearing shaft 110 extends laterally, the bearing component being essentially arranged transversely to the axis A and having a dihedral section 126 in alignment with the axis A. An upper part-fixed stop pin 128 extends from the outer side of the upper fitting part 108 parallel to the axis A and to the dihedral section 126. A compensation spring 112, having the same shape as the one in the first exemplary embodiment, is clamped onto the dihedral section 126 with a receiver in its inner end and bears with its outer end against the stop pin 128. The mode of functioning is identical to that of the first exemplary embodiment.

In the third exemplary embodiment, a vehicle seat 201 in a rear seat row of a motor vehicle has a fitting 205 on both sides for adjusting the inclination of the backrest 202 relative to its seat part 203. The fitting 205 in the shape of a lock fitting includes a seat part-fixed lower fitting part 207 and a backrest-fixed upper fitting part 208 being journaled on a bearing shaft 210 pressed to the lower fitting part 207, and being pivotable relative to the lower fitting part 207. The lower fitting part 207 includes two plate-shaped elements that are arranged parallel to one another, having a mounting space for receiving the section of the upper fitting part 208 encompassing the bearing shaft 210, as well as different locking and securing elements.

The central axis A defined by the bearing shaft 210 defines the pivoting axis of the backrest 202 and the direction referred to below as the axial direction. A compensation spring 212 made of coil steel is spirally coiled on one plane vertical to the axis A and, being the compensation spring, is bearing at one end against the lower fitting part 207 and at the other end against the upper fitting part 208. The center of the compensation spring 212 in the center of the spiral is marked M. The compensation spring 212 is shaped as a flat spring having a rectangular cross section whose larger dimension is in an axial direction.

The lower fitting part-fixed bearing shaft 210 has an end-to-end bore in an axial direction, with a bushing 220 having a cylindrical section 222 being inserted into it as a bearing component pivotable relative to the bearing shaft 210. The bushing 220 is connected, for example, by means of a screw 224 to the structure of the backrest 202 and/or is pressed to the structure of the backrest 202.

In an axial direction, the cylindrical section 222 becomes a dihedral section 226, whose symmetry axis running through the center M of the compensation spring 212 is aligned at a distance with the symmetry axis of the cylindrical section 222 coinciding with the axis A. With this eccentrically arranged dihedral section 226, the bushing 220 extends beyond the bearing shaft 210 and thus beyond the contour of the fitting 205.

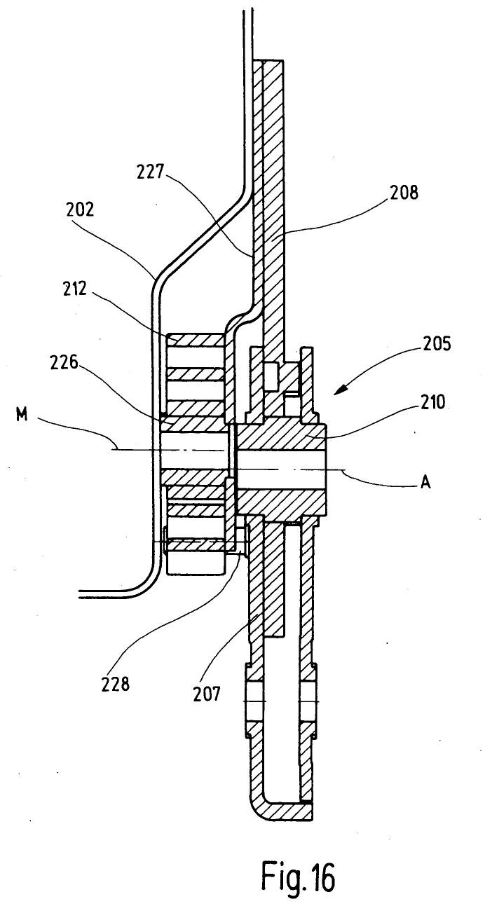

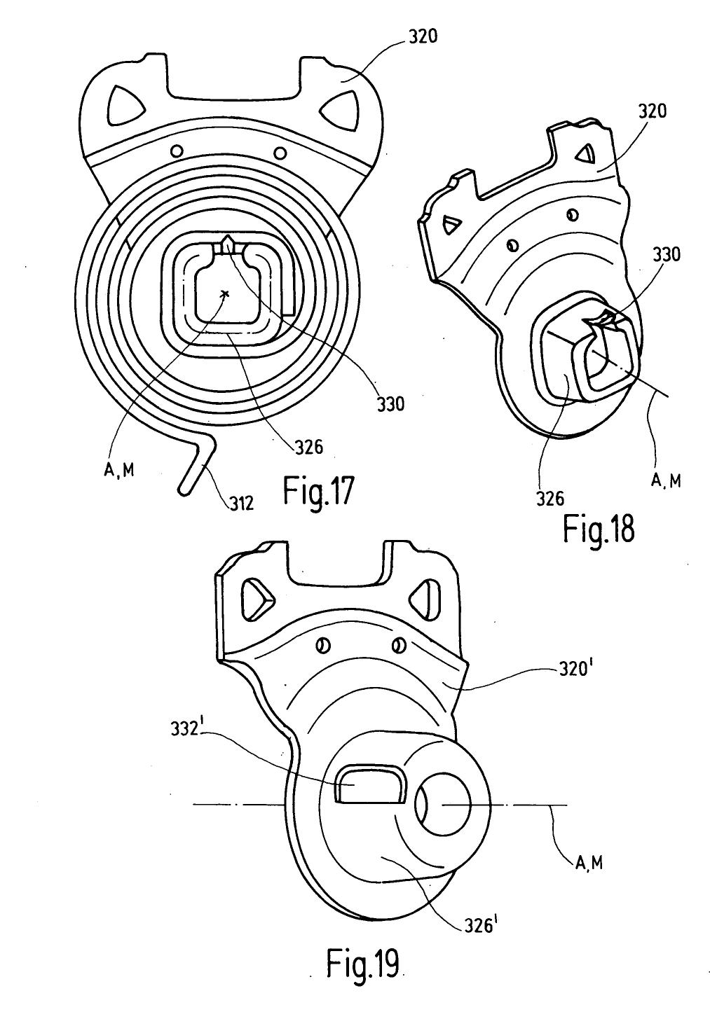

In a modified embodiment according to FIG. 16, only the dihedral section 226 of the bushing 220 remains, being pressed to an adapter tongue 227 and connected through it with the upper fitting part 208. Otherwise the embodiments are identical.

To anchor the compensation spring 212 in a rotation-fixed manner, its inner end is shaped as a receiver 212′, a large part of which is clamped on the upper part-fixed (backrest-fixed) dihedral section 226, i.e. by friction connection on large areas, by means of a pretension in the steel of the spring in the receiver 212′, for example by reason of a distance of the plane surfaces being less than the dimensions of the dihedral section 226, the similarity of the geometries preferably causing a complementary profile/interlocking connection at least in some areas, for example in the bent area. The compensation spring 212 is thus firmly attached even without pretension.

In the upright and backward inclined positions of the backrest 202, the outer end of the compensation spring 212, being pretensioned, bears on a lower part-fixed stop pin 228. The stop pin 228 extends from the outer side of the lower fitting part 207 and is arranged parallel to the dihedral section 226. A pivoting forward movement of the upper fitting part 208 is supported by the pretension of the compensation spring 212, for example to enable the backrest to swing free more easily. When the forward inclination of the backrest 202 is more than 10° from the vertical, the compensation spring 212 is in a position without pretension, i.e. it detaches itself from the stop pin 228. The weight of the backrest 202 supports further, forward movement.

By giving the bushing 220 a special shape with the eccentric arrangement of the dihedral section 226 relative to the cylindrical section 222, the compensation spring 212 functions in the fitting 205 with a nonlinear characteristic curve. The torque provided by the compensation spring 212 is the vector product of the distance from the center M of the compensation spring 212 to the stop pin 228 and the force of the compensation spring 212. When pivoting the backrest 202 and, at the same time, tensioning (or de-tensioning) the compensation spring 212, this distance changes. In the exemplary design position in FIG. 10, this distance having the function of a lever is indicated as R1. By further pivoting the backrest 202 backward, the compensation spring 212 is tensioned, thus extending this lever to R2. Since, as a rule, the force of the compensation spring 212 is approximately linearly dependent on the pivoting angle of the upper fitting parts 208, the spring torque increases in this case in a nonlinear manner. Depending on the direction and magnitude of the eccentricity of the bushing 220, a progressive or digressive characteristic curve can be achieved.

In the fourth exemplary embodiment, which is for the most part identical to the second exemplary embodiment, there is a compensation spring 312 for a lock fitting which is not represented in detail. Its upper fitting part and lower fitting part, being approximately plate-shaped and pivotable relative to one another around an axis A, are held together by means of holding plates 320 in an axial direction of the axis A. One of these holding plates 320, in this case that of the upper fitting part, is shaped as a bearing component for the compensation spring 312 by pulling a tetrahedral section 326 out of the holding plate 320 in the area of the axis A. The inner end of the spiral-shaped compensation spring 312 sits on this tetrahedral section 326, preferably clamped on as in the other exemplary embodiments. The position of the foot of the spring and therefore the alignment of the compensation spring 312 in its untensioned state can be selected according to requirements. The polyhedron can also be turned with respect to the position represented in the figure, for example by approximately 45°, i.e. its corners can point upward or downward.

For axial support of the compensation spring 312, a holding lug 330 is cut from the material of the tetrahedral section 326 along axial cutting lines and, determined by the width of the compensation spring 312, radially bent outward. The other, i.e. the outer end of the compensation spring 312 bears, pretensioned, against a stop pin of the lower fitting part which is not represented in detail. The mode of functioning of the fourth exemplary embodiment is identical with the other exemplary embodiments, particularly with the first and second exemplary embodiments. Instead of the tetrahedral section, one can also have a hexahedral section or an octahedral section or a section in the form of another polyhedron.

In a modified version, a bowl 326′ with a circular profile is pulled from a holding plate 320′ serving as bearing component. To receive the foot of the spring, an insert opening 332′ is cut into the wall of the bowl 326′. The insert opening 332′ also secures the compensation spring in an axial direction. The insert opening 332′ is cut after the bowl 326′ has been pulled out, so that the position of the insert opening 332′, and therefore the orientation of the compensation spring in its untensioned state, can be selected according to requirements. The dimensions of the insert opening 332′ in an axial direction is adjusted to the width of the compensation spring.

Both in this exemplary embodiment and in the two first exemplary embodiments, the center M of the compensation spring can be shifted with respect to the axis A, as was explained in detail for the third exemplary embodiment.

That which is claimed:

1. A fitting for a vehicle seat, comprising:
first and second fitting parts that are mounted to a bearing shaft so that the second fitting part is capable of pivoting at least through an angular range relative to the first fitting part, with the pivoting being around an axis defined by the bearing shaft; and
a spring having first and second portions that are spaced apart from one another along a length of the spring,
wherein the spring is mounted so that for at least the angular range: the first portion of the spring bears on the first fitting part, the second portion of the spring bears on a bearing component of the second fitting part, and the spring is deformed, so that the spring exerts a force that at least opposes pivoting of the second part relative to the first part in a first direction in the angular range, and
wherein at least part of the bearing component of the second fitting part is coaxial with the axis.

2. A fitting according to claim 1, wherein the spring is spirally coiled about a center of the spring so that the first portion of the spring is an outer end of the spring and the second portion of the spring is an inner end of the spring, with the center of the spring being positioned eccentrically with respect to the axis.

3. A fitting according to claim 1, wherein at least part of the bearing component is in the shape of a polyhedron or a bowl.

4. A fitting according to claim 3, wherein the spring is spirally coiled around a center of the spring so that the first portion of the spring is an outer end of the spring and the second portion of the spring is an inner end of the spring, wherein the inner end of the spring is positioned on the polyhedron or the bowl, and wherein the center of the spring is positioned eccentrically with respect to the axis.

5. A fitting according to claim 4, wherein the inner end of the spring is positioned on the polyhedron, and the polyhedron is positioned eccentrically with respect to the axis.

6. A fitting according to claim 4, wherein the inner end of the spring comprises a receiver that is clamped onto the polyhedron, with the receiver and the polyhedron frictionally interacting with one another over a substantial surface area by virtue of corresponding profiles of the polyhedron and the receiver in at least in some areas.

7. A fitting according to claim 3, wherein the polyhedron has at least one holding lug for axially securing the second portion of the spring.

8. A fitting according to claim 2, wherein the outer end of the spring bears against a pin of the first fitting part.

9. A fitting according to claim 8, wherein torque provided by the spring is a function of a distance between the pin and the center of the spring, and the pin and the spring are arranged so that the distance between the pin and the center of the spring changes as the second fitting part pivots relative to the first fitting part about the axis.

10. A fitting according to claim 1, wherein the spring is mounted so that torque provided by the spring changes nonlinearly as the second fitting part pivots relative to the first fitting part about the axis.

11. A fitting according to claim 1, wherein at least a portion of the part of the bearing component that is coaxial with the axis is positioned inside the bearing shaft.

12. A fitting according to claim 1, wherein the spring is positioned exterior of the combination of the first and second fitting parts, and the bearing component protrudes externally of the combination of the first and second fitting parts.

13. A fitting according to claim 1, wherein the fitting is in combination with the vehicle seat, with the first fitting part mounted to a first part of the vehicle seat and the second fitting part mounted to a second part of the vehicle seat so that the second part of the vehicle seat is capable of pivoting relative to the first part of the vehicle seat.

14. A fitting for a vehicle seat, comprising:
first and second fitting parts that are mounted to a bearing shaft so that the second fitting part is capable of pivoting at least through an angular range relative to the first fitting part, with the pivoting being around an axis defined by the bearing shaft; and
a spring spirally coiled about a center of the spring, with the center of the spring positioned eccentrically with respect to the axis,
wherein the spring is mounted so that for at least the angular range: an outer end of the spring bears on the first fitting part, an inner end of the spring bears on a bearing component of the second fitting part, and the spring is deformed, so that the spring exerts a force that at least opposes pivoting of the second part relative to the first part in a first direction in the angular range, and
wherein at least a part of the bearing component is in the shape of a polyhedron, the inner end of the spring is mounted to the polyhedron, and the polyhedron is positioned eccentrically with respect to the axis.

15. A fitting according to claim 14, wherein the inner end of the spring comprises a receiver that is clamped onto the polyhedron, with the receiver and the polyhedron frictionally interacting with one another over a substantial surface area by virtue of corresponding profiles of the polyhedron and the receiver in at least in some areas.

16. A fitting according to claim 14, wherein the polyhedron has at least one holding lug for axially securing the inner end of the spring.

17. A fitting according to claim 14, wherein the outer end of the spring bears against a pin of the first fitting part, the torque provided by the spring is a function of a distance between the pin and the center of the spring, and the pin and the spring are arranged so that the distance between the pin and the center of the spring changes as the second fitting pivots relative to the first fitting part about the axis.

18. A fitting according to claim 14, wherein a portion of the bearing component is coaxial with the axis and is positioned inside the bearing shaft.

19. A fitting according to claim 14, wherein the spring is positioned exterior of the combination of the first and second fitting parts, and the bearing component protrudes externally of the combination of the first and second fitting parts.

20. A fitting for a vehicle seat, comprising:
first and second fitting parts that are mounted to a bearing shaft so that the second fitting part is capable of pivoting at least through an angular range relative to the first fitting part, with the pivoting being around an axis defined by the bearing shaft; and
a spring spirally coiled about a center of the spring, with an inner end of the spring mounted on a bearing component of the second fitting part, wherein the bearing component and the center of the spring are both positioned eccentrically with respect to the axis, and
wherein the spring is mounted so that for at least the angular range: the spring is deformed and an outer end of the spring bears on the first fitting part so that the spring exerts a force that at least opposes pivoting of the second part relative to the first part in a first direction in the angular range.

21. A fitting according to claim 20, wherein the bearing component has at least one holding lug for axially securing the inner end of the spring.

22. A fitting according to claim 20, wherein the outer end of the spring bears against a pin of the first fitting part, the torque provided by the spring is a function of a distance between the pin and the center of the spring, and the pin and the spring are arranged so that the distance between the pin and the center of the spring changes as the second fitting pivots relative to the first fitting part about the axis.

23. A fitting according to claim 20, wherein a portion of the bearing component is coaxial with the axis and is positioned inside the bearing shaft.
